(19) United States
(12) Patent Application Publication
(10) Pub. No.: US 2008/0002031 A1
(43) Pub. Date: Jan. 3, 2008

(54) Multi-axis control of a fixed or moving device based on a wireless tracking location of one or many target devices

(75) Inventors: John-Paul P. Cana, McKinney, TX (US); Wylie J. Hilliard, Grand Prairie, TX (US); Stephen A. Milliren, Coppell, TX (US)

Correspondence Address: Handley Law Firm, PLLC;Roger N. Chauza, PC, PO BOX 140036, IRVING, TX, 75014, US

(73) Assignees: John-Paul P. Cana; Wylie J. Hilliard; Stephen A. Milliren

(21) Appl. No.: 11/429,898

(22) Filed: May 8, 2006

Related U.S. Application Data
(60) Provisional application No. 60/678,266, filed on May 6, 2005.

(51) Int. Cl. H04N 5/228; G01S 13/74; G08B 13/14

(52) U.S. Cl. 348/208.14; 340/572.1; 342/42

(57) ABSTRACT

A wireless tracking and control system (122) is provided for aiming a device (124) toward TAGs (134) which are mounted to subjects for tracking. The TAGS (134) preferably include locating devices for determining TAG locations and wireless transmitters for transmitting location information to a tracking and control unit (122). The tracking and control unit (122) also includes a locating device, and determines the location of a selected TAG (134) relative to the device (124). A position control unit (130) is then moved to aim the device (124) toward the selected TAG (134). In a second embodiment, a sonic tracking and control system (190) includes a sonic TAG (192), which in response to a wireless command, emits a sonic burst which is received by spaced apart transducers of a tracking and control unit (194), for determining the location the sonic TAG (192) relative to the tracking and control unit (194).

### CROSS-REFERENCE TO RELATED APPLICATION

The present application claims priority to and is a continuation in part of U.S. Provisional Application Ser. No. 60/678,266, filed May 6, 2005, entitled Multi-axis Control of a Fixed or Moving Device Based on a Wireless Tracking Location of One or Many Target Devices, invented by John-Paul P. Caña, Wylie J. Hilliard, and Stephen A. Milliren.

### TECHNICAL FIELD OF THE INVENTION

The present invention is directed tracking and control system, and in particular to a tracking and control system for selectively aiming a device, such as a video camera, at a selected subject being tracked.

### BACKGROUND OF THE INVENTION

Intelligent tracking systems have been provided for tracking subjects, such as for aiming video cameras at tracked subjects during sporting events. Such systems often utilize image processing to determine the location and track movement of subjects, aiming a video camera at a selected position of a targeted subject. Some prior art system track a ball in play using image processing to determine the positions and field of view of video cameras.

### SUMMARY OF THE INVENTION

A novel multi-axis control of a fixed or moving device based on a wireless tracking location of one or many target devices is disclosed. The control device will follow the location of one or many target devices from a fixed or moving location. Target devices are provided by target acquisition guides (“TAGs”) which mounted to subjects and configured to broadcast data necessary to allow a target and control device providing based unit to calculate location data of the target devices. This location data is then processed to cause the aiming of a device, such as a video camera, to one of many targets located by respective TAGs.

In a preferred embodiment, TAGs are mounted to subjects for tracking, and a tracking and control unit provides a base unit for receiving position information relating to a selected TAG for targeting. Preferably, the TAGs include triangulation type locating devices, such as a GPS receiver. The TAGS will determine their location and wirelessly transmit position information to the tracking and control unit. The tracking and control unit includes a locating device, and from the location information from a selected TAG determines angular displacement from a reference and distance from the tracking and control unit, or a controlled device such as a video camera. The tracking and control unit then automatically aims the controlled device toward the selected TAG.

In another embodiment, a sonic tracking and control unit is provided for wirelessly transmitting a control signal to a TAG, which causes the TAG to emit a sonic burst for a selected duration of time. The sonic tracking and control system includes at least two sonic transducers which are spaced apart for receiving the sonic burst and determining the relative position of the selected TAG from the tracking and control system to aim a controlled device, such as a video camera, toward the selected TAG. Multiple TAGs may be selectively polled by the tracking and control system to emit sonic burst for determining relative positions of the respective TAGS to the transducers of the sonic tracking and control system.

### DESCRIPTION OF THE DRAWINGS

For a more complete understanding of the present invention and the advantages thereof, reference is now made to the following description taken in conjunction with the accompanying Drawings in which FIGS. 1 through 15 show various aspects for multi-axis control of a fixed or moving device based on a wireless tracking location of one or many target devices made according to the present invention, as set forth below:

FIG. 1 is a schematic diagram depicting a tracking and control system for determining and tracking locations of various TAGs;

FIG. 2 is a schematic diagram of a tracking and control unit working in combination with a TAG for determining a relative location of the TAG from the tracking and control unit;

FIG. 3 is a block diagram of a TAG;

FIG. 4 is a lock diagram of a tracking and control unit;

FIG. 5 is a schematic diagram depicting one embodiment of a tracking and control system for automatically aiming a video camera to video selected target TAGs;

FIG. 6 is a schematic diagram of a TAG which includes a locating system;

FIG. 7 is a schematic diagram of a tracking and control unit having a TAG section in combination with a processing and control section;

FIG. 8 is a schematic diagram of a sonic operated target and control system;

FIG. 9 is block diagram of a sonic TAG;

FIG. 10 is a block diagram of a sonic target and control unit;

FIG. 11 is a schematic view of a display screen, depicting an inner portion of a field of view of a video camera which defines a central focal portion of the field of view;

FIG. 12 is a flow chart depicting a process for aiming a device at a particular selected TAG;

FIG. 13 is a schematic diagram depicting operation of a wireless tracking system using a triangulation position location system, such as a GPS receiver;

FIGS. 14A and 14B are a schematic diagram depicting a feature of selecting a TAG for targeting by various target acquisition modes; and

FIG. 15 is a flow chart depicting operation of a sonic tracking and control system.

### DETAILED DESCRIPTION OF THE INVENTION

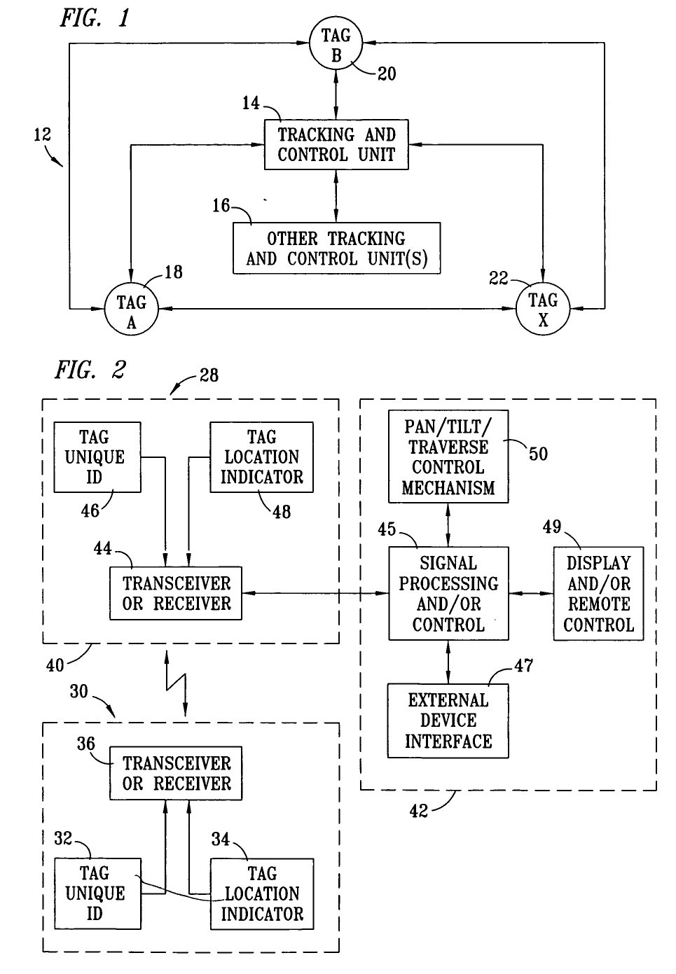

FIG. 1 is a schematic diagram depicting a tracking and control system 12 for determining and tracking locations of various TAGs 18, 20 and 22, and then utilizing the tracking locations of a selected TAG to aim a device, preferably a camera (not shown), one of the selected TAGs 18, 20 and 22. Tracking and control system 12 includes a tracking and control unit 14 which may be connected to other tracking and control units 16 for controlling multiple devices for aiming toward selected ones of the TAGs 18, 20 and 22. TAGs 18, 20 and 22, noted as TAGs A, B and X, preferably mounted to selected subjects for determining the location of the selected subjects. In a preferred embodiment, the TAGs 18, 20 and 22 will acquire location information regarding their respective positions, and transmit the location information to a tracking control unit 14 for determining the aiming of a device, such as a video camera. In a second embodiment, described below, the TAGs 18, 20 and 22 transmit sonic bursts from which the tracking and control units 14 and 16 determine the locations of the respective TAGs 18, 20 and 22. It should also be noted that the TAGs 18, 20 and 22 will also relay various position and identification information from various ones of the other TAGs 18, 20 and 22 to the tracking control unit 14, such that a location signal will be relayed from if one of the TAGs 18, 20 and 22 is distally located from the tracking and control units 14 and 16 to prevent a signal from being received by the tracking and control units 14. Additionally, the tracking and control units 14 and 16 can be operated to automatically select various ones of the respective TAGs 18, 20 and 22 according to predefined parameters, such as acceleration, proximity to a selected TAG, and location.

FIG. 2 is a schematic diagram of a tracking and control unit 28 working in combination with a TAG 30, such as one of the TAGs 18, 20 and 22 of FIG. 1. Tracking control unit 28 may be similar to that of either of the tracking control units 14 and 16 in FIG. 1. The TAG 30 includes a TAG ID, such as an identification code stored in memory. The TAG 30 further includes a TAG location indicator 34, which is preferably part of a triangulation type location system, such as often used for global positioning systems (“GPS”). The TAG unit ID 32 and the TAG location indicator 34 emit data which is transmitted via the transmitter or receiver 36 to a transmitter or receiver 44 of the tracking and control unit 28. Tracking and control unit 28 preferably includes a TAG 40, which is virtually identical to the TAG 30, but may be separate or included as part of the housing of the tracking and control unit 28 in which a process and control section 42 is located. The TAG 40 of the tracking control unit 28 includes a TAG unit ID and a TAG location indicator 48, such as GPS locator device. Information from the TAG unit ID 46 and the TAG location indicator 48, along with ID and location information from TAG 30, are transmitted from the transceiver receiver section 44 to the signal processing and control section 45 of the processing and control section 42, via wireless or wired connection. An external device interface 46 may also be provided for providing command and control input and data output from the processing and control section 45. A display and remote control interface are also provided for providing control inputs from a remote control and for display acquired information and images. A pan, tilt and traverse control mechanism 50 is connected to the processing and control section 44 for receiving control signals for controlling pan, tilt and traverse parameters for control of the device being aimed, such as a video camera.

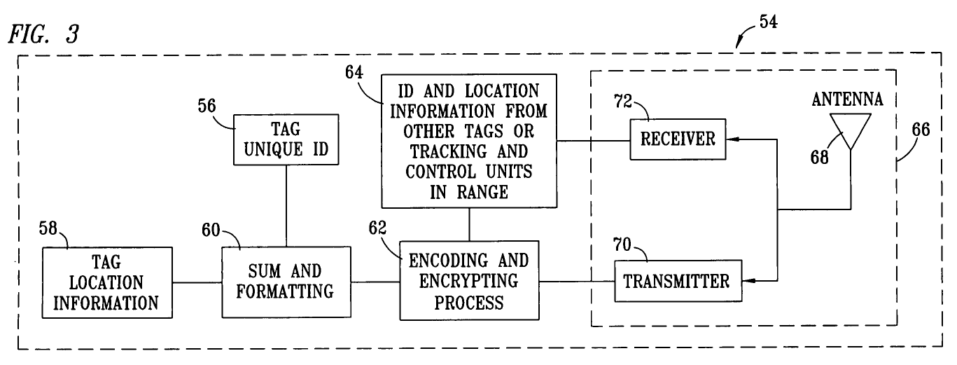

FIG. 3 is a schematic diagram a TAG 54, such as which may be used for TAGs 18, 20 and 22 of FIG. 1. The TAG 54 includes a stored TAG unique ID 56 and TAG location information section 58, such as a GPS device, or other triangulation type device for determining the location of the TAG 54. A sum and formatting processor 60 combining the TAG ID and the location information for inputting to an encoding processor 62. The encoding processor 62 may also include encrypting functions for encrypting the TAG ID and location information. A transmitter and receiver section 66 are included in the TAG 54, and includes an antenna 68 connected to the receiver 72 and the transmitter 70. The receiver 72 and a processor 64 are provided for receiving ID and location information from other TAGs and inputting such information into the processor 62 for encoding with the ID and location information of the TAG 54. This provides a relay function for relaying ID and location information from other TAGs which may be out of range for transmitting signals to a particular tracking and control unit. The encoding processor 62 inputs the encoded and encrypted TAG ID and location information to a transmitter 70, which transmits a signal through an antenna 68 to a tracking and control unit.

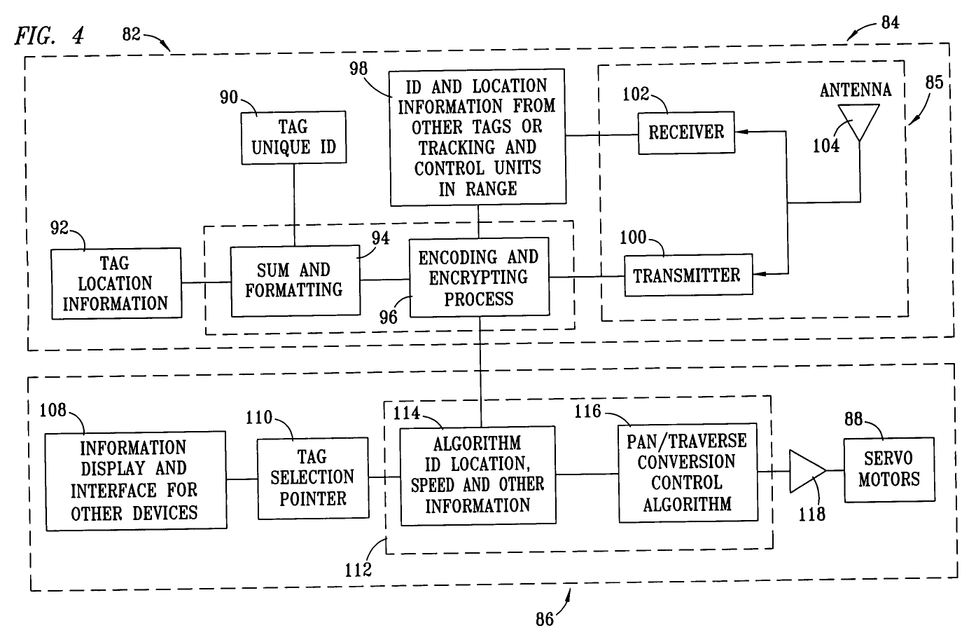

FIG. 4 is a detailed block diagram of a tracking and control unit 82, such as the tracking and control units 14, 16 and 28 of FIGS. 1 and 2. The tracking and control unit 82 includes a TAG 84 and a process and control section 86. The process and control section 86 is shown as including in servo motors 88 for operating a device to aim at a selected TAG, such as a video camera aimed at a selected player in a sports field. Various types of actuators may be used in place of servo motors 88. The TAG 84 includes a wireless communication section 85 having a transmitter 100, a receive 102 and an antenna 104. The TAG 84 of the tracking and control unit 82 includes TAG unique ID and a device 92 for determining TAG location information, such as a GPS device. The TAG unique ID 90 and the TAG location information 92 is then passed to a sum and formatting unit 94 which inputs the date to the processor 96 for encoding optionally encrypts the unique ID and TAG location information in the processor 96. The TAG 82 further includes a receiver 102 for receiving ID and location information from the other TAGs, and a processor 98 for inputting such information from other TAGS into the processor 96 for encoding with the ID and location information of the TAG 82. The encoded and optionally encryption information is then input from the processor 96 to a transmitter 100, which then transmits the combined location and ID information through antenna 104. TAG ID and location information from the encoding and encrypting process unit 96 will be input to the processor 114 of the process and control section 86, preferably via a hard wired connection. The process and control section 86 includes an interface 108 for an information display or interfacing other devices. A TAG selection pointer processor 110 is provided for determining which TAG is to be acquired and followed by device operated by the server motors 88. Processor 114 applies various algorithms to the TAG ID and location information to determine the location, speed and other information for a TAG being tracked, and the information is input to a processor 116 for applying algorithms for applying output signals to an control input 118 for providing control signals to the servo motors 88. It should be noted that the various processors in the processing and control section 86, and the TAG 84, may be provided as part of a single microprocessor or in separate devices.

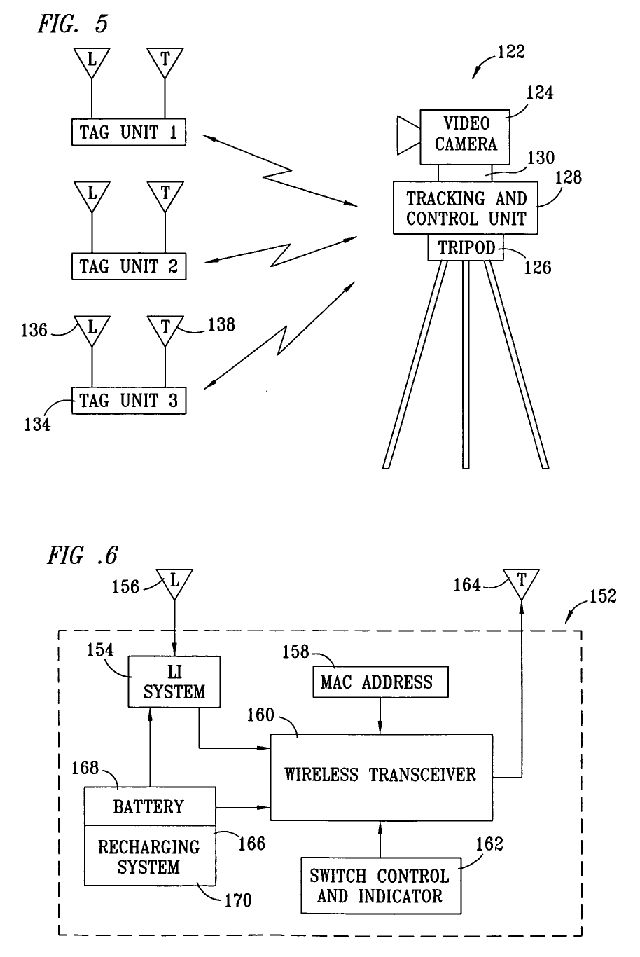

FIG. 5 is a schematic diagram depicting one embodiment of the present invention for a tracking and control system 122 for operating a video camera 124 to selectively aim the field of view of the video camera 124 at one of the TAGs 134. The video camera 124 and the tracking and control unit 128 are preferably mounted to a tripod 126, but in other embodiments the video camera 124 may be mounted to moveable devices, rather than a tripod, or manually moved by a user. The tracking and control system 122 includes the tracking and control unit 128 and a servo motor control section 130, and the TAGs 123. Each of the TAGs 134 include a locating device 136, such as a GPS receiver, and a transmitter device 138. Once the location the TAGS 134 are determined, the location and ID information for the respective TAGs 134 is transmitted to the tracking and control unit 128. The tracking and control unit 128 defines a base unit.

FIG. 6 is a schematic diagram of a TAG 152. The TAG 152 includes a locating system 154, such as a GPS receiver having an antenna 156. In other embodiments, other types of triangulation location systems may be utilized. The TAG 152 further includes a storage location 158 for a MAC address, which provides a unique ID for the TAG 152. A wireless transceiver 160 is provided for combining data from the location information system 154 and the TAG ID from the storage location 158, and transmitting the data via antenna 164 to a process and control unit. A switch control and indicator 162 is provided for determining whether power is applied to the TAG 152, and for indicating when the TAG 152 is being powered. The TAG 152 further includes a power section 166 which includes a battery 168 and an optional a recharging system 170, such that the TAG 152 may be plugged into a conventional power outlet for recharging the battery 168.

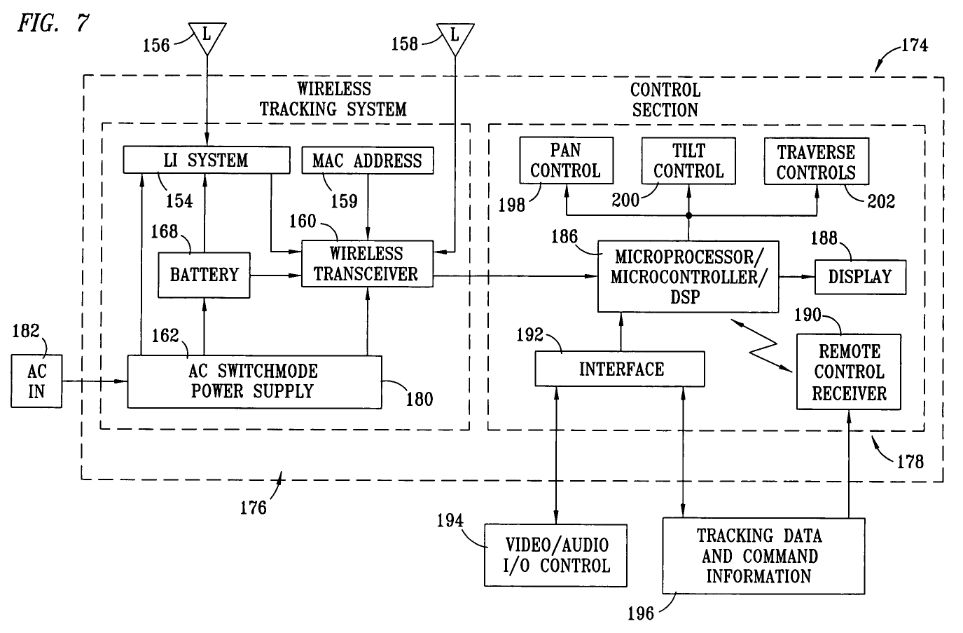

FIG. 7 depicts a schematic diagram of a tracking and control unit 174 having a TAG section 176 and a processing and control section 178. The TAG section 176 is similar to the TAG 152 of FIG. 6, having a location information system 154, such as a GPS or other type triangular or location identifying system, with an antenna 156 and data storage 159 for a MAC address which provides a unique ID for the TAG section 176. The location system 154 and the storage 159 are connected to a wireless transceiver 160. Information from the wireless transceiver 160 is transmitted via antenna 158 and/or hard wired directly to the process and control section 178. The TAG section 176 further includes battery 168, an AC switch mode power supply 180 for connecting to an A/C in connection 182 for providing power for charging the battery 168.

The process and control section 178 includes a microprocessor, or micro-controller, preferably provided by a digital signal processor (DSP) package 186. A display 188 is provided for on screen display of control functions being performed by the microprocessor 186. A remote control receiver 190 is also provided such that the tracking and control modes, in addition to manual input of tracking and control parameters, may be determined by receipt of a remote control signal from a wireless hand held remote, or other such device. An interface 192 is provided for interfacing video and audio input/output controls 194 and tracking data and command information 196 with the microprocessor 186 and external devices. The microprocessor 186 provides output signals to a pan control 198, a tilt control 200 and traverse control 202 for preferably operating stepper motors, motors, for aiming a device, such as a camera at a field of play for a sports game.

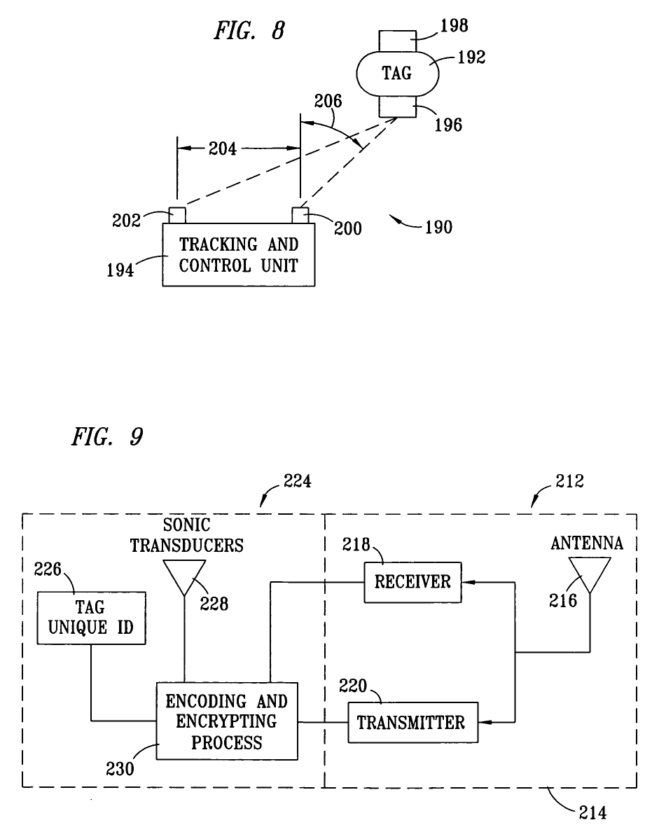

FIG. 8 is a schematic diagram of a sonic target and control system 190. The sonic target and control system 190 includes a sonic TAG 192 and a tracking and control unit 194. Preferably, the sonic TAG 192 includes two sonic transducers 196 and 198, but one or more transducers may be provided in other embodiments. The sonic TAG 192 also preferably includes a wireless communication system for receiving control data from the tracking and control unit 194, such as control data initiating a sonic burst, or a series of sonic bursts, from the transducers 196 and 198. The tracking and control unit 194 preferably includes two or more transducers 200 and 202 (two shown), spaced apart by a distance 204, such that triangulation calculations may be determined from sonic signals received from the TAG 192 by the transducers 200 and 202. In some embodiments, conventional microphones may be used for sonic transducers 200 and 202. An angle 206 and distance of the TAG 192 from the tracking and control unit 194 may be determined by comparison of relative signal strengths of the sonic signals received by the transducers 200 and 202. Additionally, sonic signal delay, from the burst command request, may be used in distance and angle calculations to determine the location of the tag 192 relative to the tracking unit 194 and to ignore echos.

FIG. 9 is a schematic diagram of a sonic TAG 212, such as may be used for the sonic TAG 192 of FIG. 8. The sonic TAG 212 includes a wireless communication section 214 and a sonic section 224. The communication section 214 includes a wireless antenna 216, a receiver 218, and a transmitter 220. The sonic section 224 includes a TAG unique ID 226, such as a MAC address stored in memory on the TAG 212. The sonic section 224 further includes a plurality one or more sonic transducers 228 (one shown). An encoding and encrypting processor 230 encodes the TAG unique ID for wireless communication signals transmitted from the TAG 212, and for comparison to received signals for determining which communication and control signals are directed to the particular TAG 212, such as from a tracking and control unit similar to the tracking and control unit 194 of FIG. 8. The TAG 212 will preferably transmit its ID via the wireless communication section 214 to a tracking and control unit when polled, and emit a burst sonic signal when a burst control signal is received from the tracking and control unit.

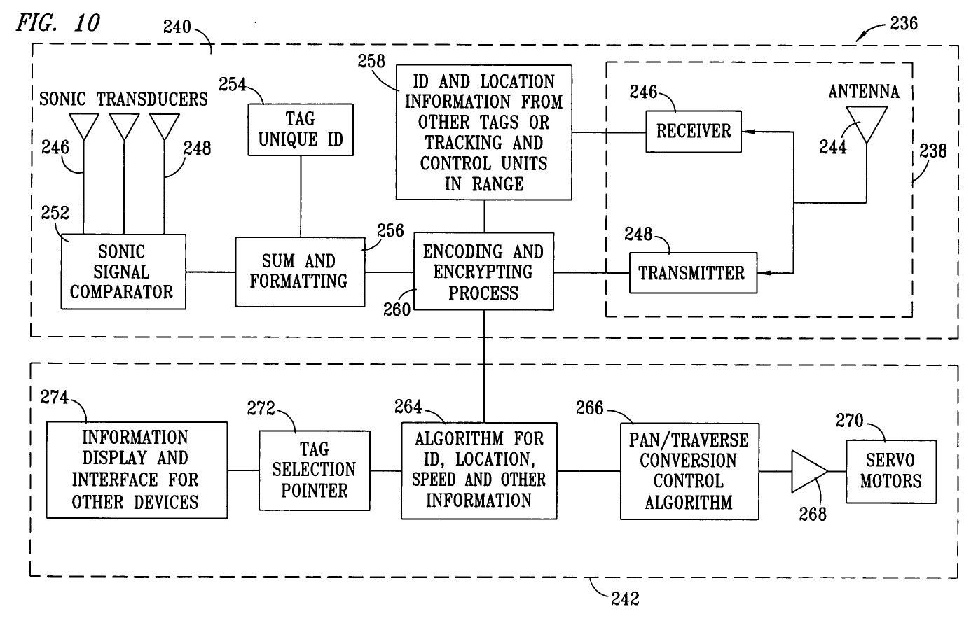

FIG. 10 is a schematic diagram of a tracking and control unit 236 having a wireless communication section 238, a sonic transducer section 240 and a control section 242. The wireless communication section 238 includes an antenna 244, a receiver 246 and a transmitter 248. The sonic transducer section 240 includes one or more sonic transducers 246 and 248 (three shown), which are spaced apart at predetermined distances. In other embodiments, conventional microphones may be used for the sonic transducers 246 and 248. A signal comparator 252 compare sonic signals received by the sonic transducers 246 and 248, preferably transmitted as a burst from a sonic tag, and determines the relative signal strength and/or phase of the sonic signals received for use in triangulation calculations for determining a location of a sonic TAG relative to the tracking and control unit 236. A sum and formatting processor 256 combines the TAG unique ID stored in memory 254 with the signal output from the sonic signal comparator 252, and inputs the location and ID information to a processor 264. The location and ID information may also be transmitted to other tracking and control units by the wireless communication system 238. Additionally, ID and location information from other tracking and control units may be received by the wireless communications section and processed by a processor 258 for passing from through the encoding and encryption processor 260 to the processor 264 in the control section 242. The processor 264 applies an algorithm for determining the ID, location, speed and other data relating to the various TAGs polled. The process section 264 outputs a signal to a processor section 266 for applying a pan, tilt and traverse conversion control algorithm. The processor 266 provides control signals to an output device 268 which powers the server motors 270 to aim a device, or video camera, at a selected TAG, such as a TAG worn by a particular player in a sports field of play. The control section 242 further includes a TAG selection pointer 272, which determines which TAG will be maintained within the field of view of the device by the control section 242. An output 274 is provided for displaying control information and for interfacing to other devices.

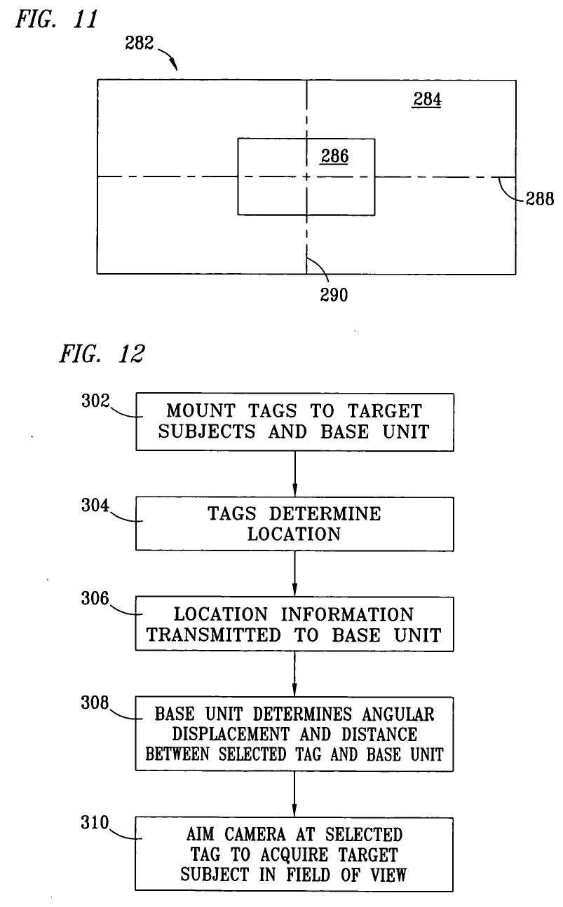

FIG. 11 is a schematic view of a display screen, depicting a field of view 282 of a video camera, such as the video camera 124 of FIG. 5. The field of view 282 has an outer region 284 and an inner focal region 286. The inner focal region 286 defines a central focal region for the field of view 282 which is a zone in which a tracking and control system preferably maintains the location of a selected TAG being tracked and recorded by the video camera. When the subject, or TAG, is within the focal region 286, the tracking and controller will not attempt to move the camera to realign the position of the video camera to prevent excessive movement of the video camera. When the TAG, or the targeted subject, exits the inner focal region 286 into the outer region 284, the tracking and control system will realign the video camera 124, such that the TAG worn by the targeted subject will be within the inner focal region 286 of the field of view 282 of the camera. Correction will be made along the axis 288 and the axis 290 to align the field of view 282 such that the selected TAG is within the inner focal region 286.

FIG. 12 is a flow chart depicting a process for aiming a device at a particular selected TAG. Step 302 depicts mounting the TAG to a selected subject for determining the locations of the TAG targeting and mounting a TAG to the base unit for determining the location of the base unit. Step 304 depicts the TAGs determining the locations in which they are disposed. Step 306 depicts the step of the location information being transmitted from the TAGs to the base unit. Step 308 depicts the step of the base unit determining an angular displacement and distance at which the selected TAG being worn by the targeted subject is located relative to the device being aimed at the targeted subject, such as a video camera 124 in FIG. 5. Step 310 depicts the step of aimed device, such as the camera, at the selected TAG to align the targeted subject in the field of view of the device being aimed.

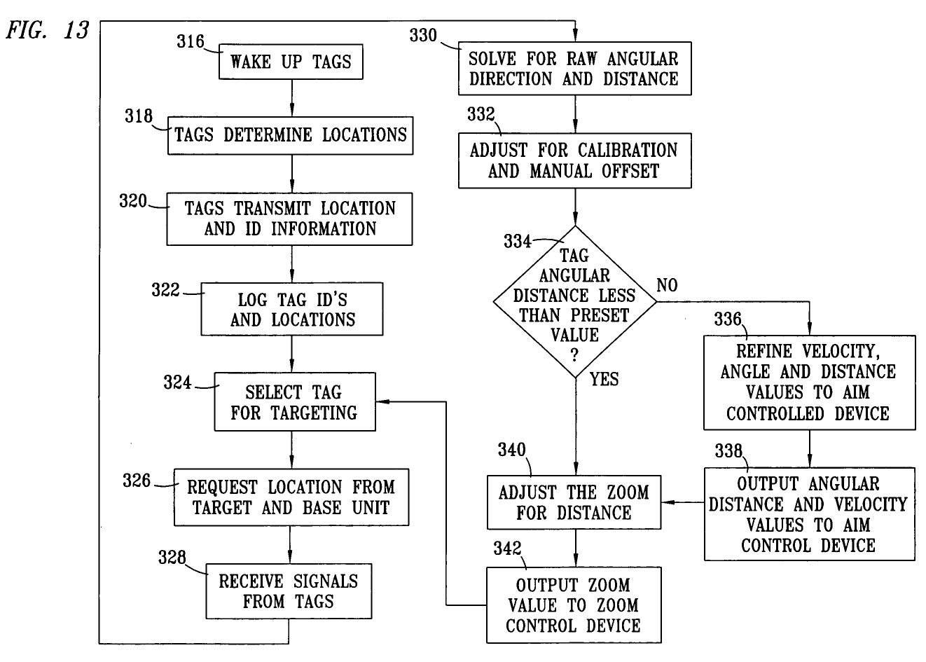

FIG. 13 is a schematic diagram depicting the operation of a wireless tracking system using a triangulation position location system, such as a GPS receiver. In step 316, the tracking and control unit will emit a signal to wake up the various TAGs associated with the tracking and control system to emit ID and position information. In step 318, the TAGs determine their locations, such as from a GPS triangulation. In step 320, the TAGs transmit ID and location information to the tracking and control unit. In step 322, the tracking and control unit logs the TAG ID and location, such as in a table for initial set up. In step 324, the subject TAG for targeting is selected according one of selectable target selection modes, such inputting a particular selected TAG ID, aiming the camera at a selected target and initiating the target and control system to follow a subject TAD. In step 326, the ID and location is requested by the target and control unit for transmission form the TAG selected in step 324 and from the TAG associated with the base unit. In step 328, a wireless signal is received from the selected TAG and from TAG associated with the base unit to determine the location of the selected TAG and the location of the base unit, such as to which a video camera is mounted. In step 330, the target and control unit performs direction and distance calculations from the location information received from the TAG selected for targeting and from location information from the TAG associated with the base unit, and determines the angular direction and distance of the selected TAG from the base unit, defined by the tracking and control unit to which a device for aiming is mounted or otherwise associated in relative position. The angular direction and distance is determined to align the selected TAG with the field of view of a selected device, such as a video camera. In step 332, an adjustment is made for calibration and manual offset, such as determined initial set up of the target and control unit. After a determination is made that the particular position of a selected TAG relative to the field of view of a device, or camera, a determination is made whether the selected TAG angular distances relative to target and control unit providing a base unit are less than a preset value, such that the selected TAG is within desired field of view, such as the inner focal zone 286 of the field of view shown in FIG. 11. If it is determined that the calculated value for an angular displacement from the location of the TAG relative to the field of view of the device, or camera, is above a preselected value, then in step 336 a determination is made of the angular distances and velocities at which the device, or camera, should be moved to locate the selected TAG within the inner focal zone of the device or camera's field of view. It should be noted that velocity computations may be made from sequential location information of the selected TAG to determine a precalculated region in which the subject is likely to be moved within the subsequent time period. In step 338, angular distance and velocity values to control motors for moving the controlled device, or video camera, are determined, and then the process proceeds to steps 340 and 342. If in step 334, it is determined that the angular distances are less than preset values, the process will proceed to steps 340 and 342 to determine whether to adjust the zoom of the device, or video camera. In step 340, an adjustment is made to the zoom which device focus on the targeted subject based on the determined distance of the selected TAG from the camera. In step 342 zoom values and control signals are applied to focus the video camera on location of the selected TAG. The process then return to step 324 to determine whether a different subject TAG is selected for targeting or whether to repeat the process for the currently selected TAG.

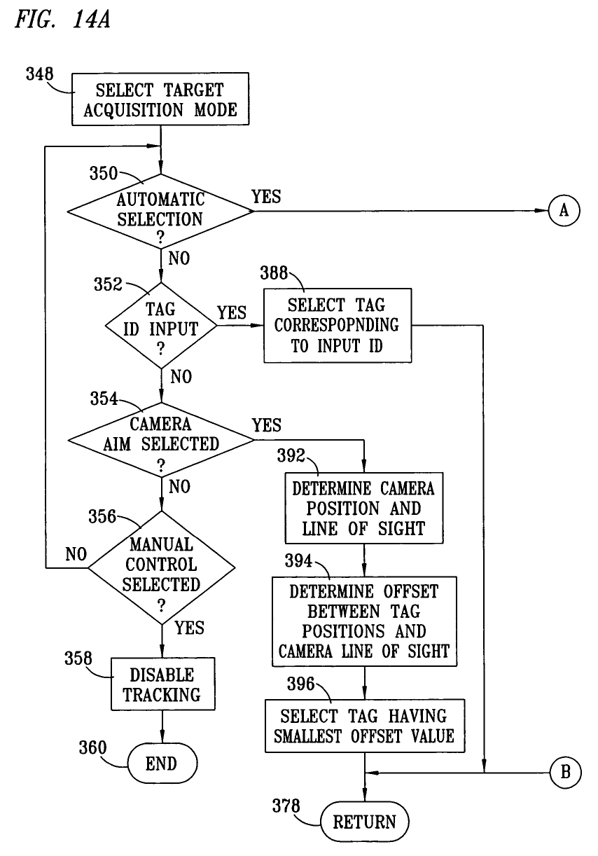

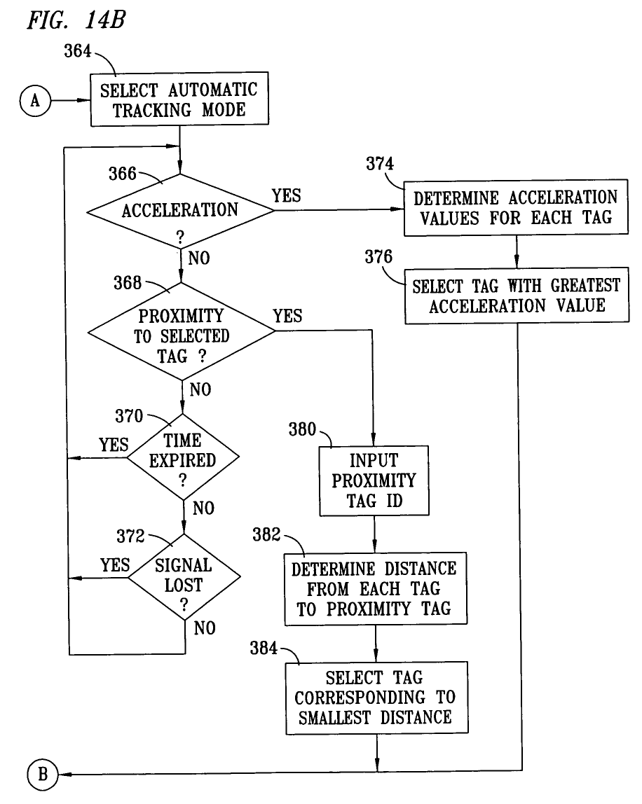

FIGS. 14A and 14B together are a schematic diagram depicting step 324 in FIG. 13, that of selecting a TAG for targeting by various target acquisition modes. In step 348, a target acquisition mode is selected. In the preferred embodiment, various modes for selecting a TAG for targeting are provided. Preferably, the process will proceed from step 348 to step 350 to determined whether an automatic target tracking mode is selected. If not, then to step 352 to determine whether a mode of selecting the targeted TAG by manual input of a selected TAG ID. The default mode is preferably to input an ID for a TAG for targeting. If the TAG ID Input mode is not selected, then the process proceeds to step 354 to determine whether a camera aim mode has been selected, in which the camera is aimed at a TAG and the ID of the TAG closest to the line of sight of the device of camera is automatically selected, a manual target selection mode. If the process determines that the camera aim mode is not selected, the process will proceed to step 356 and determine whether a manual control mode is selected. In manual control mode, a user manually aims the controlled device, either by use of remote control, such as a wireless controller, or by manually moving the controlled device, or camera. If it is determined in step 356 that manual control mode is not selected, the process will then return back to step 350. If in step 356 a determination is made that manual control mode is selected, the process moves to step 358 and automatic tracking is disabled in step 358. The process then proceeds to an end step, in which the target and control system goes into a standby mode waiting for input from the user. Then, the camera may be manually aimed by either a remote control device, such as a wireless control device, or by manual manipulation of the controlled device, such as a video camera, by the user.

If a determination is made in step 350 that automatic acquisition mode is selected, the process proceeds to step 364 in which a user selects the parameter for automatic tracking mode. Preferably, two modes for automatic tracking are available. The first is acceleration mode and the second is proximity selection mode. In acceleration mode, a TAG having the greatest acceleration for a time period is selected. Acceleration mode presumes that a subject, such as a player on a sports field, with the greatest acceleration will be the one closest to the game play and be desirable for video recording. In proximity mode, a TAG in closest proximity to a predetermined proximity TAG is selected for targeting. The proximity TAG may be mounted to a game ball, such as for basketball, football and soccer, or a hockey puck, and such, and the TAG worn by a person closest to the game ball would be selected for tracking and targeting, such as with a video camera, for locating in a central focal region of the video camera. The process proceeds from step 364 to step 366, in which a determination is made whether acceleration mode is selected. If a determination is made that acceleration mode is not selected, the process proceeds to step 368 and a determination is made of whether proximity mode has been selected. If proximity mode has not been selected, the process proceed to step 370 to determine whether preselected time has expired for a selected tracking mode and then to step 372 to determine if the signal from a selected TAG has been lost. If it is determined in step 370 that time has expired or in step 372 that the signal of a selected TAG is no longer being received, the process will return back to step 366. If it is determined in step 372 that the signal has been lost, the process will return to step 366. In the described embodiment, if a determination is made in step 372 that the signal has not been lost from the selected TAG, then the process will return to step 366.

If in step 366 a determination is made that acceleration mode is selected, the process proceeds to step 374 and determines acceleration values for each of the TAGs associated with tracking a control unit. In step 376 the TAG with the greatest acceleration value is selected for tracking. The process then proceeds to step 378 to return to the process to target the selected TAG having the greatest acceleration value. Preferably, the acceleration value for each TAGs may be averaged over an increment of time, such that an instantaneous acceleration and deceleration will not cause the tracking and control unit to hunt among various subject TAGs subject to brief incremental acceleration. The acceleration of the various TAGs may be determined by repeated polling and determination of calculated acceleration values by the tracking and control unit, or acceleration determination may be determined by the respective TAGs and transmitted to the tracking and control unit seeking a target for tracking. Onboard determination of acceleration of the TAGs may be accomplished by comparing various position values determined by locating devices onboard the respective TAGs, or by an onboard accelerometer.

If a determination is made in step 368 that proximity mode is selected, the process proceeds to step 380 in which a user inputs the ID for a proximity TAG. Once the proximity TAG ID has been input, the process proceeds to step 382 and determine the distance from each TAG to the selected proximity TAG. Then, in step 384, the TAG corresponding to the smallest distance from the proximity TAG will be selected for targeting and tracking by the target and control until. It should also be noted that this process is being used in reference to FIG. 13, the time value for smoothing such that a selected time will be applied for tracking the particular subject target will be selected in the process steps 330 and 332 for smoothing the tracking changes in the camera. Once the target corresponding to smallest distance is selected, the processor proceeds to the return step 378, and, in reference to FIG. 13, returns to step 326 and request the location from the subject TAG.

If a determination is made in step 354 that camera aim mode is selected, the process determines which of the active TAGs closest to a line of sight for the video camera and acquires the closest of the active TAGs as the target for tracking. The first process proceeds from step 354 to step 392, and a camera position and line of sight is determined for the video camera. Preferably, the line of sight of the video camera is a calculated line centrally disposed within the central focal region of the video camera. Then, in step 394 the offset from the locations of each of the TAGs to the line of sight is determined. In step 396 the TAG having the smallest offset value to the line of sight of the video camera is selected as the target for aiming the video camera. Preferably, once a user selects that the camera line of sight mode, the tracking and control unit will continue to track the same, selected target until a new target is selected by a user aiming the video camera at a selected target and selecting line of sight mode a second time, or selecting an alternative target acquisition mode to determine the subject for the camera to track, follow and video.

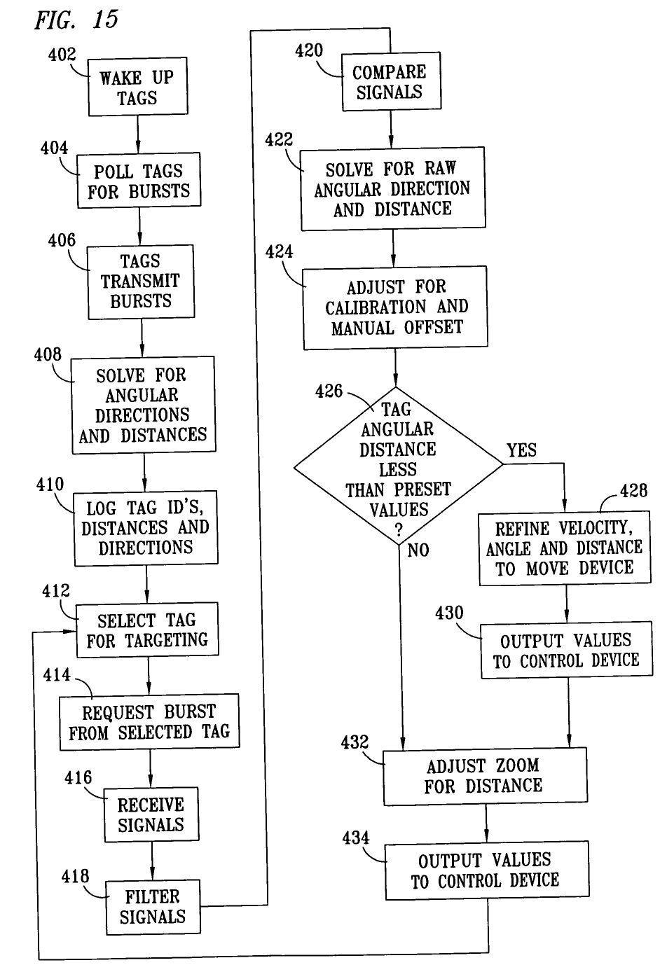

FIG. 15 is a flow chart depicting operation of a sonic tracking and control system, such as that shown in FIGS. 8-10. In step 402, the tracking and control unit will sent a signal to activate, or 1 wake up, the associated TAGs. In step 404 the tracking and control unit will sequentially poll each of the associated TAGs, sending a wireless command signal for each TAG to emit a sonic burst. In step 406, each of the TAGs emit a burst when each is separately poled during different time intervals by the tracking and control unit. In some embodiments, TAGs for emitting sonic bursts of different frequencies may be used, such that TAGs of different sonic burst frequencies may be simultaneously used and the signals filtered according to frequency by the tracking and control unit. In the preferred embodiment, each of the TAGs associated with a selected tracking and control unit will be poled singularly, and the tracking and control unit will listen for a sonic burst from a selected one of each of the associated TAGs during a particular time interval in step 406. In step 408, the tracking and control unit will solve for the angular distance and directions between the poled TAGs and the target and control unit, which provides a base unit. In step 410, the tracking and control unit will log the TAG IDs and distance and direction information. In step 412, the tracking and control unit will choose a subject TAG according to a selected target acquisition mode, such as that shown in FIGS. 14A and 14B. In step 414, the tracking and control unit will request a burst from the selected TAG associated with the target subject. In step 416, the tracking and control unit will receive the burst from the selected TAG at least two, spaced sonic transducers. More than two sonic transducers may be used for receiving the sonic signal burst from the selected TAG. In step 418, the received sonic signals are filtered for reducing noise, and in those embodiments with TAGs emitting sonic burst at different frequencies, to filter the signals from TAGs operating at non-selected frequencies as not being selected by the particular target and control unit. In step 420, the received signals are compared to determine the angular displacement and distance information of the selected TAG relative to the target and control unit. In step 422, the angular direction and distance raw values are determined. In step 424, the signals are adjusted for calibration and manual offset, such as for values determined when initially setting up the particular target and control system. In step 426, it is determined whether the TAG angular distance from the central focal region is less than preset values, such that it is within the field of view of the central focal region, of the video camera, such as discussed in reference to FIG. 11. If in step 426 it is determined that the angular distances are greater than the preset values, the process proceeds to step 428 and refines the velocity and angle and distance calculations to determine the distance the video camera should be displaced to place the subject TAG within the central focal region of the video camera. In step 430, calculated output values are emitted to control the controlled device, or video camera. The process will then proceed to the step 432. If in step 426 it is determined that the angular distance is less than the preset values, the process will proceed directly to step 432 for determining adjustments to the zoom of the camera. In step 432, adjustments to the zoom are determined according to calculated distances from of the selected TAG from the target and control unit. Once the desired adjustments are determined, the process proceeds to the step 434 and desired output values are applied to adjust the zoom of the camera. The process then returns to step 412 and a subject TAG is selected for tracking and targeting.

Preferably, the tracking and control system tracks cumulative values applied to the zoom for determining values for the zoom. In other embodiments, measurement of zoom values may be determined by sensors. Preferably, the zoom is stepped according to a table which relates zoom factors to a distance of an object from a tracking and control unit, or a camera, such as, for example, that shown in the following Table A:

TABLE A
ZOOM FACTORS FOR CALCULATED DISTANCES

| DISTANCE (FT) | ZOOM FACTOR |
|---|---|
| 1-9.9999 | 0 |
| 10-19.999 | 3 |
| 20-29.999 | 5 |
| 40-79.999 | 8 |
| 80 and above | max |

In other embodiments, different types of TAG location indicators other than GPS may be used, such as processing the phases shifts or signal strengths of various sonic transmitters disposed at selected locations, or wireless transmitters of selected frequency disposed at various locations. One such embodiment would be for video taping or recording positions in a sports field of play, in which transmitter beacons are placed at selected locations determined or input the tracking and control unit. Known locations could include selected distance from the corners of the rectangular field of play. A tracking and control unit determines position and the relative position to the various transmitters, and then is used to calculate distance information from a TAG location indicator to process the various data received and determine the relative location of a TAG of various transmitters adjacent the field of play. In some embodiments, the TAG may be mounted to a game ball, such as for basketball, football and soccer, or a hockey puck, and such, and selected for placing in an inner focal region of a video frame for recording.

Thus the present invention provides automatic tracking of objects for with devices, such as video cameras. In a preferred embodiment, TAGs are mounted to subjects for tracking, and a tracking and control unit provides a base unit for receiving position information relating to a selected TAG for targeting. The tracking and control unit then automatically aims the controlled device toward the selected TAG. In another embodiment, a sonic tracking and control unit wirelessly transmits a control signal to a selected TAG, causing the TAG to emit a short sonic burst which is received by the sonic tracking and control system to aim a controlled device, such as a video camera, toward the selected TAG.

Although the preferred embodiment has been described in detail, it should be understood that various changes, substitutions and alterations can be made therein without departing from the spirit and scope of the invention as defined by the appended claims.

What is claimed is:

1. A method for aiming a controlled device at a selected subject, the method comprising the steps of:
providing a first TAG having a wireless communication section and a first location device for determining a location of the first TAG;
further providing a tracking and control unit having a wireless receiver for receiving location information of the first TAG, the tracking and control unit having a second location device for determining a second location, for the controlled device;
determining the first location of the first TAG with the first location device;
transmitting first location information to the receiver of the tracking and control unit;
determining the second location for the controlled device with the second location device;
processing the location information in comparison to the second location for the controlled device to determine the relative position of the first TAG from the controlled device;
determining control values for moving the controlled device to aim at the first TAG; and
moving the controlled device to aim at the first TAG in response to the determined relative position of the first TAG relative to the controlled device.

2. The method according to claim 1, wherein the step of determining the location of the first TAG with the location device comprises the steps of receiving triangulation type position signals with a GPS receiver, and determining the position from the received position signals.

3. The method according to claim 2, wherein the step of determining the location of the controlled device with the second location device comprises the steps of receiving triangulation type position signals with a GPS receiver, and determining the position from the received position signals.

4. The method according to claim 3, wherein the controlled device is a video camera, and the method further comprises the steps of:
recording video of the selected subject;
determining the position of the selected subject relative to a view frame of the video camera, in which the view frame includes an inner focal region and an outer focal region;
determining the position of the selected subject according to the first location of the first TAG; and
automatically moving the video camera to dispose the selected subject within the inner focal region in response to determining the selected subject is disposed within the outer focal region.

5. The method according to claim 1, further comprising the steps of:
providing a second TAG having a second wireless communication section and a third location device for determining a third location, which is for the second TAG;
mounting the first TAG to a first subject;
mounting the second TAG to a second subject;
determining the third location relating to the second TAG with the third location device;
transmitting third location information from the second wireless communication section to the receiver of the tracking and control unit; and
determining the selected subject at which to aim the controlled device according to an automatic process defined by location parameters relating to the location of the first TAG mounted to the first subject and the third location relating to the second TAG mounted to the second subject.

6. The method according to claim 5, wherein the step of selecting the subject further comprises the step of the location parameters being defined by the step of comparing the accelerations of the first TAG and the second TAG.

7. The method according to claim 5, further comprising the steps of:
providing a third TAG having a third wireless communication section and a fourth location device for determining a fourth location, for the third TAG;
mounting the third TAG to a third subject;
determining a fourth location relating to the third TAG with the third location device;
transmitting fourth location information from the third wireless communication section to the receiver of the tracking and control unit; and
wherein the step of selecting the subject at which to aim the controlled device comprises automatically selecting the closest of the first TAG and the second TAG to the third TAG.

8. The method according to claim 5, wherein the step of selecting the subject further comprises the step of the location parameters comprises the steps of:
determining a line of sight for the controlled device;
comparing the distances of each of the first and second TAGS to the line of sight of the controlled device to determine an offset value for each of the first and second TAGS; and
wherein the step of selecting the subject at which to aim the controlled device comprises automatically selecting the first TAG and the second TAG which have the smallest offset value, to determine which of the first and second subjects are closest to the line of sight of the controlled device.

9. A method for aiming a video camera at a selected subject, the method comprising the steps of:
providing a first TAG having a wireless communication section and a first location device for determining a location of the first TAG;
further providing a tracking and control unit having a wireless receiver for receiving location information of the first TAG, the tracking and control unit having a second location device for determining a second location, for the video camera;
determining the first location of the first TAG with the first location device;
transmitting first location information to the receiver of the tracking and control unit;
determining the second location for the video camera with the second location device;
processing the location information in comparison to the second location for the video camera to determine the relative position of the first TAG from the video camera;
determining control values for moving the video camera to aim at the first TAG; and
moving the video camera to aim at the first TAG in response to the determined relative position of the first TAG relative to the video camera;
recording video of the selected subject;
determining the position of the selected subject relative to a view frame of the video camera, in which the view frame includes an inner focal region and an outer focal region;
determining the position of the selected subject according to the first location of the first TAG; and
automatically moving the video camera to dispose the selected subject within the inner focal frame in response to determining the selected subject is disposed within outside of the inner focal region.

10. The method according to claim 9, wherein the step of determining the location of the first TAG with the location device comprises the steps of receiving triangulation type position signals with a GPS receiver, and determining the position from the received position signal; and wherein the step of determining the location of the video camera with the second location device comprises the steps of receiving triangulation type position signals with a GPS receiver, and determining the position from the received position signals.

11. The method according to claim 9, further comprising the steps of:
providing a second TAG having a second wireless communication section and a third location device for determining a third location, which is for the second TAG;
mounting the first TAG to a first subject;
mounting the second TAG to a second subject;
determining the third location relating to the second TAG with the third location device;
transmitting third location information from the second wireless communication section to the receiver of the tracking and control unit; and
determining the selecting subject at which to aim the video camera according to an automatic process defined by location parameters relating to the location of the first TAG mounted to the first subject and the third location relating to the second TAG mounted to the second subject.

12. The method according to claim 11, wherein the step of selecting the subject further comprises the step of the location parameters being defined by the step of comparing the accelerations of the first TAG and the second TAG.

13. The method according to claim 11, further comprising the steps of:
providing a third TAG having a third wireless communication section and a fourth location device for determining a fourth location, for the third TAG;
mounting the third TAG to a third subject;
determining a fourth location relating to the third TAG with the third location device;
transmitting fourth location information from the third wireless communication section to the receiver of the tracking and control unit; and
wherein the step of selecting the subject at which to aim the video camera comprises automatically selecting the closest of the first TAG and the second TAG to the third TAG.

14. The method according to claim 11, wherein the step of selecting the subject further comprises the step of the location parameters comprises the steps of:
determining a line of sight for the controlled device;
comparing the distances of each of the first and second TAGS to the line of sight of the video camera to determine an offset value for each of the first and second TAGS; and
wherein the step of selecting the subject at which to aim the video camera e comprises automatically selecting the first TAG and the second TAG which have the smallest offset value, to determine which of the first and second subjects are closest to the line of sight of the controlled device.

15. A method for aiming a controlled device at a selected subject, the method comprising the steps of:
providing a TAG having a wireless receiver and a sonic transducer, and a tracking and control unit having a wireless transmitter and at least two, spaced apart sonic transducers;
emitting a wireless command signal from the wireless transmitter of the tracking and control unit;
receiving the wireless command signal with the wireless receiver of the TAG;
emitting a sonic burst with the sonic transducer of the TAG in response to receiving the wireless command signal;
receiving the sonic burst with the two, spaced apart sonic transducers of the tracking and control unit, and emitting transducer signals in response thereto;
processing the transducer signals to determine the relative position of the TAG from the device being aimed;
determining control values for moving the device to aim at the TAG; and
moving the device to aim at the TAG in response to the determined relative position of the TAG relative to the device.

16. The method according to claim 15, wherein the step of emitting the sonic bursts further comprises the step of emitting a series of sonic bursts in response to receiving the wireless command signal.

17. The method according to claim 17, further comprising the steps of:
determining the position of the selected subject relative to a view frame defined for the controlled device, in which the view frame includes an inner focal region and an outer focal region;
determining the position of the selected subject according to the first location of the first TAG; and
automatically moving the controlled device to disposed the selected subject within the inner focal frame in response to determining the selected subject is disposed within the outer focal region.

18. The method according to claim 15, further comprising the steps of:
providing a second TAG having a second wireless communication section and a third location device for determining a third location, which is for the second TAG;
mounting the first TAG to a first subject;
mounting the second TAG to a second subject;
determining the third location relating to the second TAG with the third location device;
transmitting third location information from the second wireless communication section to the receiver of the tracking and control unit; and
determining the selected subject at which to aim the controlled device according to an automatic process defined by location parameters relating to the location of the first TAG mounted to the first subject and the third location relating to the second TAG mounted to the second subject.

19. The method according to claim 18, wherein the step of selecting the subject further comprises the step of the location parameters being defined by the step of comparing the accelerations of the first TAG and the second TAG.

20. The method according to claim 18, further comprising the steps of:
providing a third TAG having a third wireless communication section and a fourth location device for determining a fourth location, for the third TAG;
mounting the third TAG to a third subject;
determining a fourth location relating to the third TAG with the third location device;
transmitting fourth location information from the third wireless communication section to the receiver of the tracking and control unit; and
wherein the step of selecting the subject at which to aim the controlled device comprises automatically selecting the closest of the first TAG and the second TAG to the third TAG.

21. The method according to claim 18, wherein the step of selecting the subject further comprises the step of the location parameters comprises the steps of:
determining a line of sight for the controlled device;
comparing the distances of each of the first and second TAGS to the line of sight of the controlled device to determine an offset value for each of the first and second TAGS; and
wherein the step of selecting the subject at which to aim the controlled device comprises automatically selecting the first TAG and the second TAG which have the smallest offset value, to determine which of the first and second subjects are closest to the line of sight of the controlled device.
